(19) United States
(12) Patent Application Publication
(10) Pub. No.: US 2013/0241843 A1
(43) Pub. Date: Sep. 19, 2013

(54) ELECTRONIC DEVICE AND METHOD FOR CONTROLLING ILLUMINATION DEVICE

(71) Applicant: CHENG-HUANG LU, Shenzhen City (CN)

(72) Inventor: CHENG-HUANG LU, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/480,720

(22) Filed: May 25, 2012

(30) Foreign Application Priority Data
Mar. 15, 2012 (CN) 201210067601.5

(51) Int. Cl. G06F 3/041

(52) U.S. Cl. 345/173

(57) ABSTRACT

A computerized method controls illumination devices within a monitoring area using an electronic device via a plurality of controllers. Each of the controllers controls one of the illumination devices correspondingly. A schematic plan of the monitoring area is acquired and divided into a plurality of regions according to distribution of the illumination devices within the monitoring area. When any of the regions is touched, the electronic device sends a control signal to the corresponding controller to turn on/off the illumination device within the target region.

### BACKGROUND

1. Technical Field

Embodiments of the present disclosure relate to an electronic device and a method for controlling illumination devices.

2. Description of Related Art

In many homes and offices, a plurality of illumination devices are installed according to the layout of the homes and offices. Each of the illumination devices may correspond to a separate controller. With the increase of the installed illumination devices, the management and operation of the controllers corresponding to the illumination devices may become inconvenient, and even prone to misoperation.

### BRIEF DESCRIPTION OF THE DRAWINGS

FIG. 1 is a schematic block diagram illustrating one embodiment of an electronic device in communication with a plurality of controllers for controlling illumination devices in a particular monitoring area.

FIG. 2 illustrates a schematic plan of the particular monitoring area.

FIG. 3 is a schematic diagram illustrating an example of a touch operation on the schematic plan of FIG. 2.

FIG. 4 is a flowchart of one embodiment showing a method for controlling illumination devices within the particular monitoring area using the electronic device of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

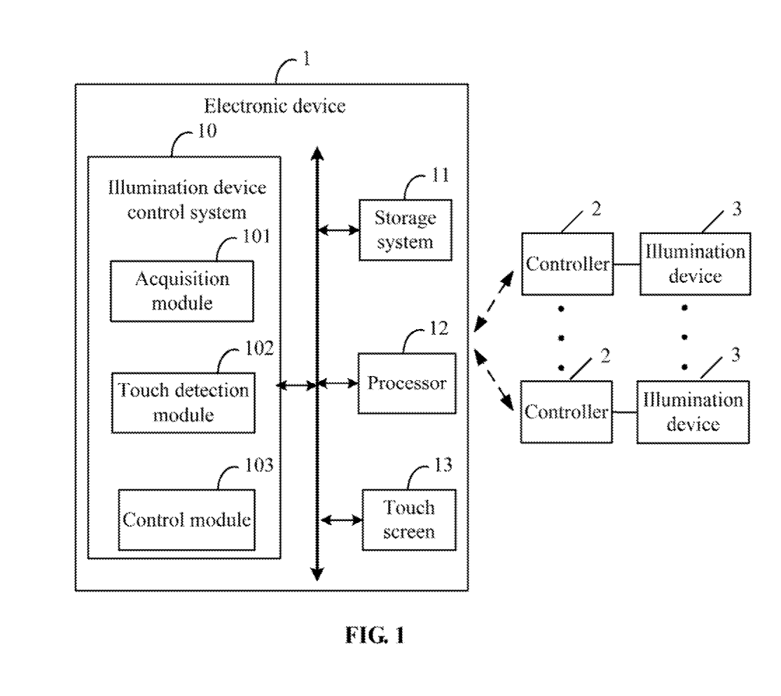

FIG. 1 illustrates one embodiment of an electronic device 1 in communication with a plurality of controllers 2 for controlling illumination devices 3 in a particular monitoring area. The electronic device 1 includes an illumination device control system 10 for controlling the illumination devices 3 via the controllers 2. In the embodiment, each controller 2 controls one of the illumination devices 3 to turn on/off. The electronic device 1 may communicate with each of the controllers 2 through wireless communication technologies, such as BLUETOOTH and WIFI.

The electronic device 1 further includes a storage system 11, a processor 12, and a touch screen 13. In one embodiment, the electronic device 1 may be, for example, a panel computer, a smart phone, a personal digital assistant (PDA), or other similar device. FIG. 1 shows only one example of the electronic device 1, and the electronic device 1 can include more or fewer components than those shown in the embodiment, or have a different configuration of the components.

The illumination device control system 10 may include a plurality of programs in the form of one or more computerized instructions stored in the storage system 11 and executed by the processor 12 to perform operations of the electronic device 1. In the embodiment, the illumination device control system 10 includes an acquisition module 101, a touch detection module 102, and a control module 103. In general, the word “module”, as used herein, refers to logic embodied in hardware or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

The acquisition module 101 acquires a schematic plan of the particular monitoring area, divides the schematic plan into a plurality of regions according to distribution of the illumination devices 3 within the monitoring area, wherein each of the controllers 2 corresponds to a region for controlling the illumination device 3 within the region. The schematic plan of the monitoring area may be drawn using any graphic software, and stored in the storage system 11.

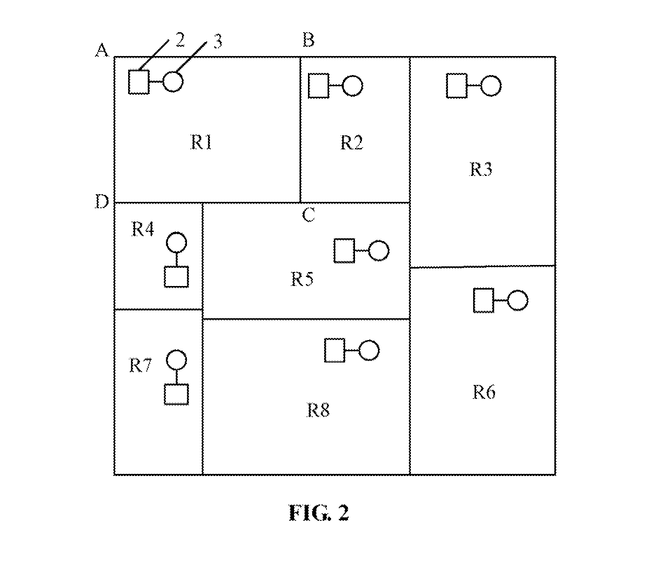

FIG. 2, is a schematic plan of the monitoring area according to one embodiment of the present disclosure. In this embodiment, eight illumination devices 3 are installed at different locations within the monitoring area. The schematic plan may be divided into eight rectangular regions (i.e., R1, R2 . . . R8 as shown in FIG. 2), according to distribution of the eight illumination devices 3. Each of the illumination devices 3 illuminates a sub area of the monitoring area, and each sub area of the monitoring area corresponds to one of the eight rectangular regions. FIG. 2 shows each of the eight rectangular regions corresponds to one of the controllers 2 for controlling a corresponding illumination device 3 within each of the rectangular regions.

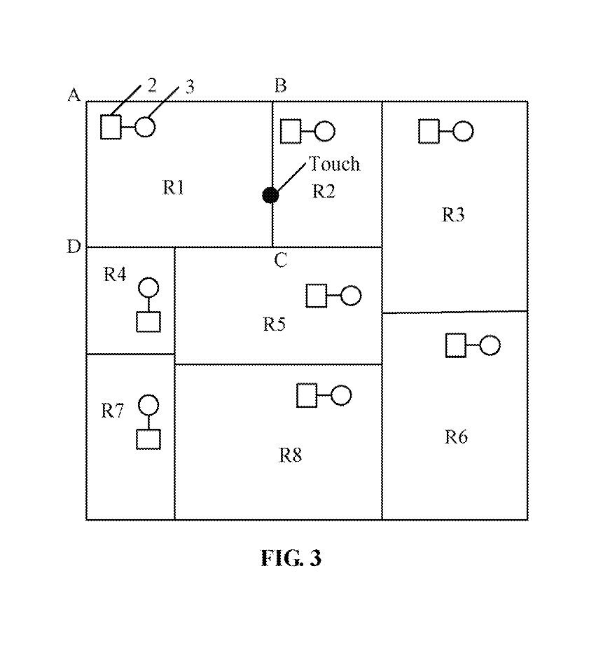

The touch detection module 102 detects a touch operation on the touch screen 13 when the schematic plan is activated and displayed on the touch screen 13, and determines one of the regions which is touched as a target region. In one example, assuming that coordinates of four vertexes A, B, C and D of a rectangular region (i.e., R1 of FIG. 3) on the touch screen 13 correspondingly are (X1, Y1), (X2, Y2), (X3, Y3), and (X4, Y4), and a coordinate of the detected touch operation is (X, Y). If Xmin≦X≦Xmax and Ymin≦Y≦Ymax, the rectangular region having the vertexes A, B, C and D is touched and is determined as the target region, wherein the Xmin represents a minimum value among X1 to X4, the Xmax represents a maximum value among X1 to X4, the Ymin represents a minimum value among Y1 to Y4, and the Ymax represents a maximum value among Y1 to Y4.

In this embodiment, if the touch operation is located at an intersection of two or more of the regions, each of the two or more regions is regarded as the target region. In one example, as shown in FIG. 3, if the touch operation is located at the segment BC which is the intersection of the regions R1 and R2, each of the regions R1 and R2 may be regarded as the target region. In other embodiments, none of the two or more regions is regarded as the target region, and the touch detection module 102 further notifies a user to reselect one of the regions as the target region.

The control module 103 sends a control signal to the controller 2 corresponding to the target region to turn on/off the illumination device 3 within the target region. The electronic device 1 and each of the controllers 2 may include a BLUETOOTH module, and the electronic device 1 may send the control signal using the BLUETOOTH module. The control signal may be a predetermined digital signal according to which of the regions is determined as the target region. For example, if the target region is the rectangular region R1 in FIG. 3, the control signal may be 0001. If the target region is the rectangular region R2 in FIG. 3, the control signal may be 0010. Accordingly, the control signal may be 0011, 0100, 0101, 0110, 0111 or 1000, if the target region is one of the rectangular regions R3 to R8 of FIG. 3.

When the controller 2 receives the control signal, the controller 2 controls the corresponding illumination device 3 to turn on/off. For example, if the illumination device 3 is turned off before the control signal is received, the controller 2 turns on the illumination device 3 when the control signal is received. Accordingly, if the illumination device 3 is turned on before the control signal is received, the controller 2 turns off the illumination device 3 when the control signal is received.

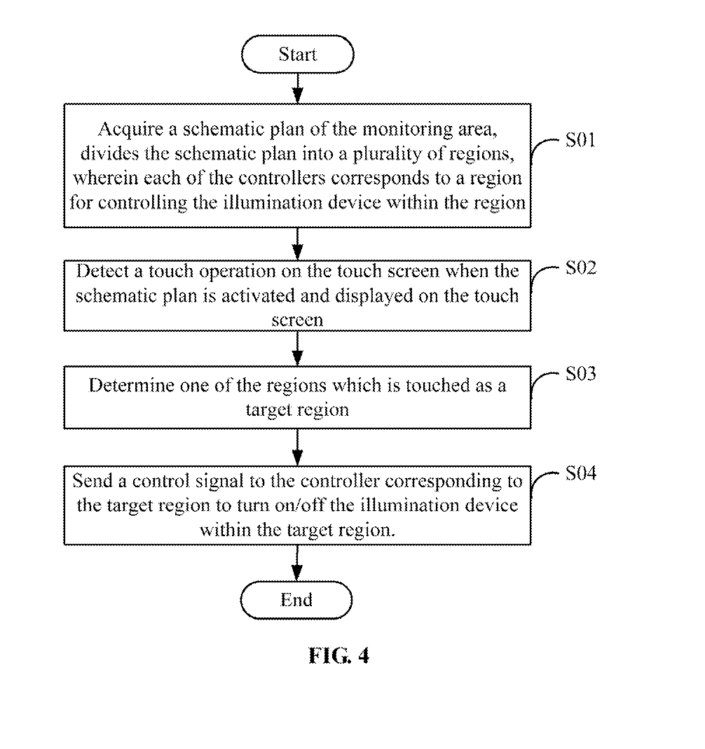

FIG. 4 is a flowchart of one embodiment of a method for controlling illumination devices within the particular monitoring area using the electronic device of FIG. 1. Depending on the embodiment, additional steps may be added, others removed, and the ordering of the steps may be changed.

In step S01, the acquisition module 101 acquires a schematic plan of the particular monitoring area, divides the schematic plan into a plurality of regions according to distribution of the illumination devices 3 within the monitoring area, wherein each of the controllers 2 corresponds to a region for controlling the illumination device 3 within the region.

In step S02, the touch detection module 102 detects a touch operation on the touch screen 13 when the schematic plan is activated and displayed on the touch screen 13.

In step S03, the touch detection module 102 determines one of the regions which is touched as a target region. Details of determination of the target region as described above.

In step S04, the control module 103 sends a control signal to the controller 2 corresponding to the target region, to turn on/off the illumination device 3 within the target region. In the embodiment, the control signal may be a digital signal. When the controller 2 receives the digital signal, the controller 2 controls the corresponding illumination device 3 within the target region to turn on/off.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A computerized method for controlling illumination devices using an electronic device, the electronic device in communication with a plurality of controllers, each of the controllers controlling one of the illumination devices within a monitoring area, the electronic device comprising a touch screen, the method comprising:
acquiring a schematic plan of the particular monitoring area;
dividing the schematic plan into a plurality of regions according to distribution of the illumination devices within the monitoring area, wherein each of the controllers corresponds to a region for controlling the illumination device within the region;
detecting a touch operation received by the touch screen when the schematic plan is activated and displayed on the touch screen;
determining at least one of the regions which is touched as a target region; and
sending a control signal to the controller corresponding to the target region to turn on/off the illumination device within the target region.

2. The method according to claim 1, wherein the control signal is a digital signal, and the controller controls the illumination device within the target region to turn on/off when the controller receives the digital signal.

3. The method according to claim 1, wherein the determining step comprises:
when the touch operation is located at an intersection of two or more of the regions, determining each of the two or more regions as the target region.

4. The method according to claim 1, wherein the determining step comprises:
notifying a user to reselect one of the regions as the target region, when the touch operation is located at an intersection of two or more of the regions.

5. The method according to claim 1, wherein the electronic device and each of the controllers comprise a BLUETOOTH module and the electronic device communicates with each of the controllers using the BLUETOOTH module.

6. An electronic device in communication with a plurality of controllers, each of the controllers controlling one of illumination devices within a monitoring area, the electronic device comprising:
a touch screen;
a storage system;
at least one processor; and
one or more programs stored in the storage system and executed by the at least one processor, the one or more programs comprising:
an acquisition module that acquires a schematic plan of the particular monitoring area, divides the schematic plan into a plurality of regions according to distribution of the illumination devices within the monitoring area, wherein each of the controllers corresponds to a region for controlling the illumination device within the region;
a touch detection module that detects a touch operation received by the touch screen when the schematic plan is activated and displayed on the touch screen, and determines at least one of the regions which is touched as a target region; and
a control module that sends a control signal to the controller corresponding to the target region to turn on/off the illumination device within the target region.

7. The electronic device according to claim 6, wherein the control signal is a digital signal and the controller controls the illumination device within the target region to turn on/off when the controller receives the digital signal.

8. The electronic device according to claim 6, when the touch operation is located at an intersection of two or more of the regions, the touch detection module determines each of the two or more regions as the target region.

9. The electronic device according to claim 6, wherein the touch detection module further notifies a user to reselect one of the regions as the target region, when the touch operation is located at an intersection of two or more of the regions.

10. The electronic device according to claim 6, wherein the electronic device and each of the controllers comprise a BLUETOOTH module and the electronic device communicates with each of the controllers using the BLUETOOTH module.
